(19) United States
(12) Patent Application Publication
(10) Pub. No.: US 2009/0218247 A1
(43) Pub. Date: Sep. 3, 2009

(54) FLEXIBLE MOISTURE-BARRIER PACKAGES AND METHODS OF PRODUCING SAME

(76) Inventor: Rami Abraham Kalfon, Kfar-Shmuel (IL)

Correspondence Address: DARBY & DARBY P.C., P.O. BOX 770, Church Street Station, New York, NY, 10008-0770, US

(21) Appl. No.: 12/096,404

(22) PCT Filed: Dec. 20, 2006
(86) PCT No.: PCT/IL2006/001466

§ 371 Date: Oct. 22, 2008

Related U.S. Application Data
(60) Provisional application No. 60/751,601, filed on Dec. 20, 2005.
(60) Provisional application No. 60/754,864, filed on Dec. 30, 2005.
(60) Provisional application No. 60/763,268, filed on Jan. 31, 2006.

(51) Int. Cl. B65D 85/00; B32B 9/04; B32B 7/12; B32B 38/04

(52) U.S. Cl. 206/459.1; 428/411.1; 428/354; 428/192; 156/250

(57) ABSTRACT

A flexible package for products sensitive to moisture, includes a front flexible sheet having moisture-barrier properties; and a back flexible sheet having moisture-barrier properties bonded along its peripheral edges to the peripheral edges of the front flexible sheet except for one edge to allow for the introduction of the product into the interior of the package and then the sealing of the package by bonding the unbonded edges. At least a section of the front flexible sheet having moisture-barrier properties is optically transparent such as to permit a moisture-indicator to be introduced with the product into the interior of the package before bonding the unbonded edges of the two sheets, and to be optically observed through the transparent section after the package has been sealed. Also described are various multi-layer constructions for the two flexible sheets, and methods of producing such packages to also include anti-static properties.

### FIELD AND BACKGROUND OF THE INVENTION

The present invention relates to flexible moisture-barrier packages, sometimes called pouches, for packaging products which are sensitive to moisture. The invention also relates to methods of producing such packages.

Many products are sensitive to moisture and have shelf lives which are greatly influenced by the storage conditions of humidity, temperature, oxygen, etc. Various means have been developed to improve the storage conditions of such products and thereby to prolong their shelf life. For example, many packages include desiccants for absorbing moisture (water vapor), and/or gas absorbents for absorbing gases, in order to prolong the shelf life of the packaged product. In other techniques, nitrogen gas, argon gas, etc., is introduced into the package of the product, or air is withdrawn from the interior of the package to produce a vacuum therein. Humidity indicators are also introduced into the interior of the package to allow visual monitoring of the humidity within the package.

Metal foil, particularly aluminum foil, is widely used in flexible barrier packaging. The barrier properties of aluminum foil, both for moisture and for gases, are extremely high and very cost effective. However, aluminum foil of less than 20 microns includes small pinholes which substantially reduce the barrier level of such foils. Aluminum foils are also very sensitive to folding and cracking, which may substantially increase the permeability of the foil with respect to air, humidity (water vapor) and gases.

Transparent humidity-barrier films are also known including transparent polymer substrates having vacuum-coated moisture-barrier layers thereover, such as alumina, silicon oxides, etc. However, the barrier-capability of such films, particularly with respect to humidity, is significantly lower than that of aluminum foil barrier films.

Many constructions of packages have been developed to include desiccants for absorbing moisture and/or moisture indicators to indicate whether moisture has penetrated into the interior of the package. For example, U.S. Pat. No. 5,293,996 describes a package including separate compartments for humidity indicators and desiccants; whereas U.S. Pat. No. 5,875,892 describes a package in which a humidity indicator is secured to the package and viewable through a transparent window. Both types of packages require the introduction of the moisture indicator, at the time of producing the package which complicates the production process. Moreover, the production of such a package for use with one type of product, requiring a specific moisture indicator, would not be usable with respect to other products requiring a different type of moisture indicator and/or desiccant.

In addition, many products to be packaged are not only sensitive to moisture, but are also sensitive to static electricity and/or electromagnetic fields. Accordingly, it is desirable, in many applications, to include anti-static and/or electromagnetic (EMI) shielding properties to the packaging, to enable the packaging material to dissipate electrostatic charges. Such anti-static coatings are generally applied to the outer faces of the packages; since anti-static coatings are not easily bondable to polymers, and therefore present problems when applied to the inner faces of the two polymer sheets to be bonded together to form the package.

### OBJECTS AND BRIEF SUMMARY OF THE PRESENT INVENTION

An object of the present invention is to provide a flexible moisture-barrier package having advantages in one or more of the above respects. More particularly, an object of the present invention is to provide a flexible moisture-barrier package which can be produced in volume and at low cost, which can be used for a wide variety of products requiring different moisture-indicators, desiccants, or the like, and which can use standard packing-making or pouch-making machines. Yet another object of the invention is to provide laminate containing a metal foil, particularly aluminum foil, layer providing a high moisture-barrier capability and a low sensitivity to folding and cracking. A further object is to provide a transparent-polymer multi-layer sheet also having a high moisture-barrier capability.

A still further object of the present invention is to provide a method of making such flexible moisture-barrier packages which method is susceptible for volume-production at low cost and can also be used for applying anti-static properties to the packages.

According to one aspect of the present invention, there is provided a flexible package for a product sensitive to moisture, comprising: a front flexible sheet having moisture-barrier properties; and a back flexible sheet having moisture-barrier properties joined along its peripheral edges to the peripheral edges of the front flexible sheet except for one edge thereof to define a compartment allowing the introduction of the product and then the sealing of the package by bonding the unjoined edges; wherein at least a section of the front flexible sheet having moisture-barrier properties is optically transparent, such as to permit a moisture-indicator, a desiccant, a bar code label, and/or an RFID (radio frequency identification device) to be introduced with the product into the interior of the package before bonding the one edge of the two sheets, and to be optically observed through the transparent section after the package has been sealed by bonding said one edge.

According to further features in the described preferred embodiments, the back flexible sheet and the front flexible sheet are of an opaque material, particularly a laminate containing aluminum foil, having moisture-barrier properties, except for the transparent section of the front flexible sheet, which is of an optically transparent material having moisture-barrier properties.

In one described preferred embodiment, the transparent section of the front flexible sheet extends across the complete width of the front flexible sheet.

In a second described preferred embodiment, the transparent section of the front flexible sheet includes at least one transparent window formed in the front flexible sheet, the window being of smaller width and length than the width and length of the front flexible sheet. In the described embodiment, the transparent section of the front flexible sheet includes a plurality of windows such as to permit a moisture indicator, as well as a bar code label, and/or a radio-frequency identification device (RFID) also to be introduced with the product into the interior of the package before sealing and to be optically observed after sealing.

In a third described embodiment, the front flexible sheet is optically transparent for its complete surface area.

According to further features in the described preferred embodiments, the back flexible sheet includes a polymer substrate, a vacuum-coated moisture barrier layer thereover, and a metal foil of less than 20 microns over the moisture-barrier layer. The metal foil is preferably of aluminum, and the moisture-barrier layer is preferably a vacuum-coated metal or oxide. Such a construction has been found to effectively avoid the pinhole problem with aluminum foils, even when extremely thin foils are used. In the described preferred embodiments, the aluminum foil is less than 20 microns in thickness, preferably about six microns, but may even be less when thinner foils become available.

According to further features in the described preferred embodiments, the transparent section of the front flexible sheet is a multi-layer lamination including a first transparent polymer substrate having a first vacuum-coated moisture-barrier layer bonded to a second transparent polymer substrate having a second vacuum-coated moisture-barrier layer. It is contemplated that the multi-layer lamination may include even a third transparent polymer substrate having a third vacuum-coated moisture-barrier layer. Such a multi-layer construction produces a moisture barrier which is substantially superior to the single layer constructions heretofore used.

According to a still further feature included in a described preferred embodiments, the inner faces of the front and back flexible sheets are coated with an anti-static coating to dissipate electrical charges, and/or to provide electromagnetic shielding.

According to another aspect of the present invention, there is provided a flexible package comprising: a front flexible sheet having moisture-barrier properties; and a back flexible sheet having moisture-barrier properties joined along its peripheral edges to the peripheral edges of the front flexible sheet except for one edge thereof to define a compartment allowing the introduction of the product and then the sealing of the package by bonding the unjoined edges; wherein at least one of the flexible sheets includes a polymer substrate, a vacuum-coated moisture-barrier layer thereover, and a metal foil of less than 20 microns over the moisture-barrier layer.

According to a still further aspect of the present invention, there is provided a flexible package for a product sensitive to moisture comprising: a front flexible sheet having moisture-barrier properties; and a back flexible sheet having moisture-barrier properties joined along its peripheral edges to the peripheral edges of the front flexible sheet except for one edge thereof to define a compartment allowing the introduction of the product and then the sealing of the package by bonding the one edge; wherein at least one of the flexible sheets is a multi-layer lamination including a first polymer substrate having a first vacuum-coated moisture-barrier layer, bonded to a second polymer substrate having a second vacuum-coated moisture-barrier layer.

According to yet another aspect of the present invention, there is provided a flexible package, comprising: a front flexible sheet; and a back flexible sheet joined along its peripheral edges to the peripheral edges of the front flexible sheet except for one edge thereof to define a compartment allowing the introduction of the product and then the sealing of the package by bonding the one edge; wherein the inner faces of the front flexible sheet and back flexible sheet are coated with an anti-static and/or electromagnetic shielding coating to dissipate electrical charges.

The invention also provides a flexible sheet comprising a first polymer substrate having a first vacuum-coated moisture-barrier layer, bonded to a second polymer substrate having a second vacuum-coated moisture-barrier layer.

According to a still further aspect, the invention also provides a method of making flexible packages, comprising: feeding two flexible polymer sheets, each having a moisture-barrier layer, through a longitudinally-extending path, with a surface of each sheet facing a surface of the other sheet; bonding the two sheets together along longitudinally-spaced transverse lines to define a plurality of individual compartments each having an open end; and cutting the bonded sheets along longitudinally-spaced transverse cut lines to define a plurality of individual packages each having a compartment and an open end for inserting a product into the respective compartment; wherein the surfaces of the two sheets facing each other are coated with an anti-static coating and/or electromagnetic shielding before the two sheets are bonded together along the transverse bond lines, to thereby impart anti-static properties, and/or to provide electromagnetic shielding, to each of the packages.

In one described embodiment, the anti-static and/or electromagnetic shielding coating is applied to each of the facing surfaces except the outer margins to be bonded together, and the bonding is effected by intermittently activating a heating element extending transversely across the two flexible sheets.

In another described embodiment, the anti-static coating and/or electromagnetic shielding is applied over the complete surfaces of each of the facing surfaces of the two sheets; an adhesive is applied over the anti-static coatings only along the outer margins to be bonded together; and the bonding is effected by intermittently activating a heating element extending transversely across the two flexible sheets in the longitudinally-extending path.

In yet a third described embodiment, the anti-static coating and/or electromagnetic shielding is applied over the complete surface of each of the facing surfaces of the two sheets; a heat-activatable adhesive is printed over the anti-static coating of at least one sheet, only along the outer margin to be bonded to the other sheet; and the bonding is effected by feeding the two sheets between heater rollers for activating the heat-activatable adhesive.

As will be described more particularly below, a flexible package constructed in accordance with the foregoing features of the invention can be produced with a high degree of moisture barrier properties, and with anti-static and/or electromagnetic shielding, properties if desired, can be manufactured in volume and at low cost, and can also accommodate different types of moisture indicators, desiccants, bar codes and/or RDIF's whenever desired to be introduced into the package, without changing the production apparatus or method. In addition, the invention permits the humidity indicators, desiccants, etc. to be applied to the product being packaged, rather than to the package itself, which provides a number of other important advantages.

Further features and advantages of the invention will be apparent from the description below.

### BRIEF DESCRIPTION OF THE DRAWINGS

The invention is herein described, by way of example only, with reference to the accompanying drawings, wherein:

FIG. 1 pictorially illustrates one form of flexible moisture-barrier package (or pouch) constructed in accordance with the present invention, FIG. 1 illustrating the product being partially inserted into the package;

FIG. 2 illustrates the main parts of the flexible moisture-barrier package of FIG. 1;

FIG. 3 schematically illustrates an example of a process and apparatus for producing the flexible package of FIG. 1;

FIG. 4 pictorially illustrates the multi-layer laminate containing an aluminum-foil used for the back flexible sheet and for the upper and lower sections of the front flexible sheet in the flexible package of FIG. 1;

FIG. 5 pictorially illustrates the multi-layer, transparent-polymer structure in the optically-transparent section of the front flexible sheet of the FIG. 1 package;

FIG. 6 pictorially illustrates another flexible package (or pouch) constructed in accordance with the present invention;

FIG. 7 illustrates a method which may be used in producing the package of FIG. 6;

FIG. 8 illustrates yet another construction of flexible package in accordance with the present invention;

FIG. 9 schematically illustrates a method of making flexible packages in accordance with the present invention to include also anti-static or electromagnetic shielding properties;

and FIG. 10 schematically illustrates another method of making flexible packages including anti-static properties or electromagnetic shielding properties.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

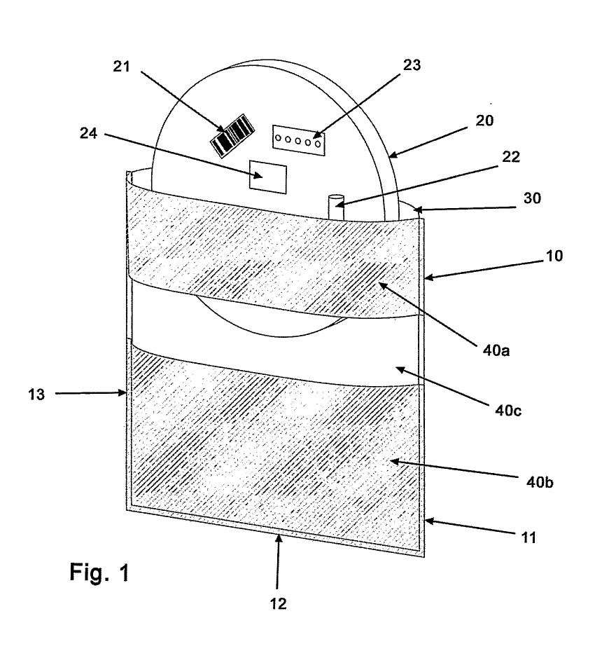

With reference to FIG. 1, there is illustrated a flexible moisture-barrier package, generally designated 10, constructed in accordance with the present invention for packaging a product 20 sensitive to moisture. As one example, product 20 to be packaged may be a roll containing electronic chips, which are sensitive to moisture. When product 20 is received within package 10 and the package completely sealed, the package provides a low moisture environment for the electronic chips carried by roll 20, thereby not only prolonging the shelf life of the chips while still in the package, but also better assuring reliable operation of the chips when used in electronic circuitry.

Because of the sensitivity to moisture of the product 20 to be packaged, the product, or the interior of the package 10, is provided with a humidity indicator 21 and also with a desiccant 22 for absorbing humidity within the package. Product 20 illustrated in FIG. 1 is also shown as being provided with a bar code label 23 for identification purposes, and also with a radio-frequency identification device (RFID) 24 to permit identification, via radio-frequency, of the product within the package.

The flexible package 10 illustrated in FIG. 1 is made of a back flexible sheet, generally designated 30, having high moisture-barrier properties, and a front flexible sheet, generally designated 40, also having high moisture-barrier properties. The two flexible sheets 30 and 40 are bonded together along their peripheral edges 11, 12 and 13, except for the top edges which are left open to allow the introduction of the product 20 into the interior of the package. After the product 20 has been introduced into the package, the top edges of the two flexible sheets 20, 30 are bonded together to seal the product within the interior of the package.

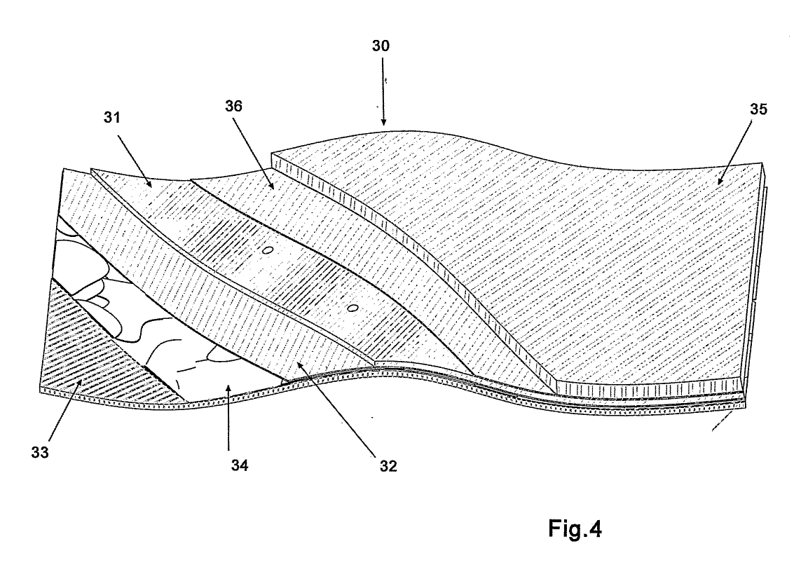

The back flexible sheet 30 is made of an opaque sheet material having high moisture-barrier properties. A preferred construction for the back flexible sheet 30, including a laminate containing aluminum foil, is described below with respect to FIG. 4.

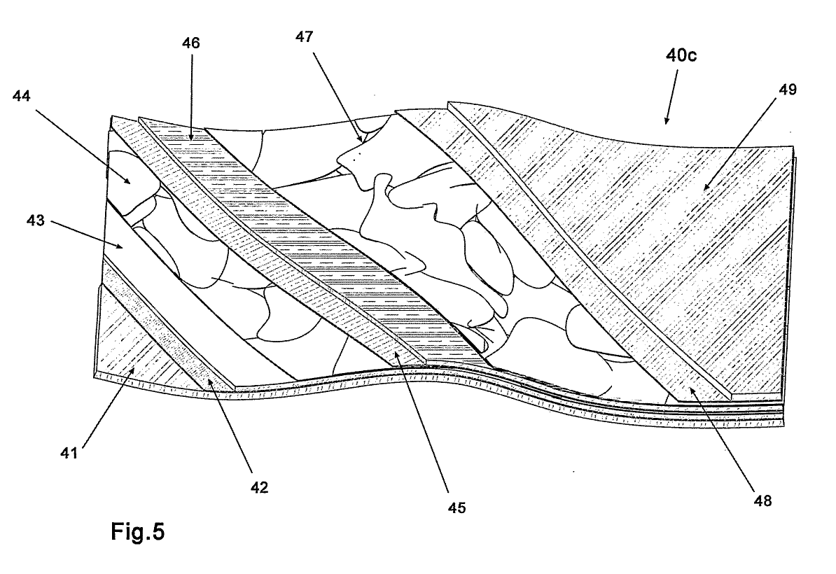

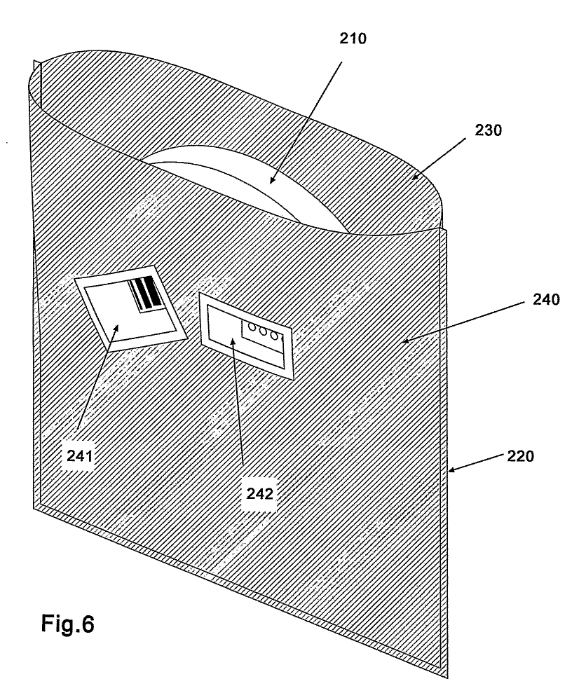

The front flexible sheet 40 is made of three strips, namely upper and lower strips 40a, 40b, joined to intermediate strip 40c. The upper and lower strips 40a, 40b are also of an opaque material, whereas the intermediate strip 40c is of an optically-transparent material having moisture-barrier properties, to enable visually observing the product 20 within the package, and particularly the humidity indicator 21, the bar-code label 23 and/or the RFID 24 carried by the product. The optically-opaque sections, 40a, 40b of the front flexible sheet 40 are also preferably of the laminate containing aluminum-foil construction illustrated in FIG. 4, whereas the optically-transparent intermediate section 40c is preferably of a transparent-polymer laminate construction illustrated in FIG. 5.

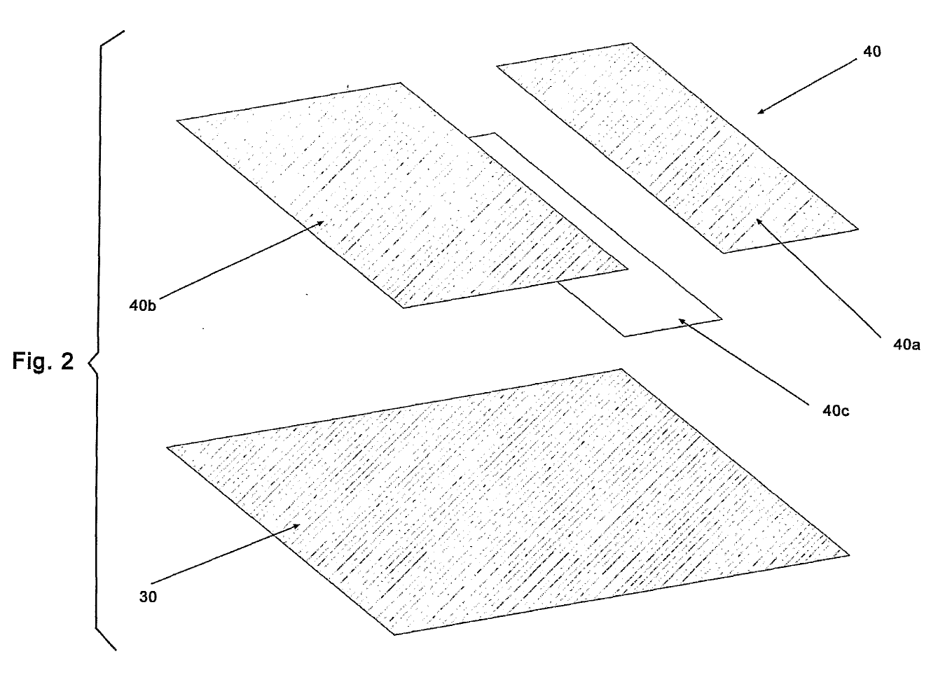

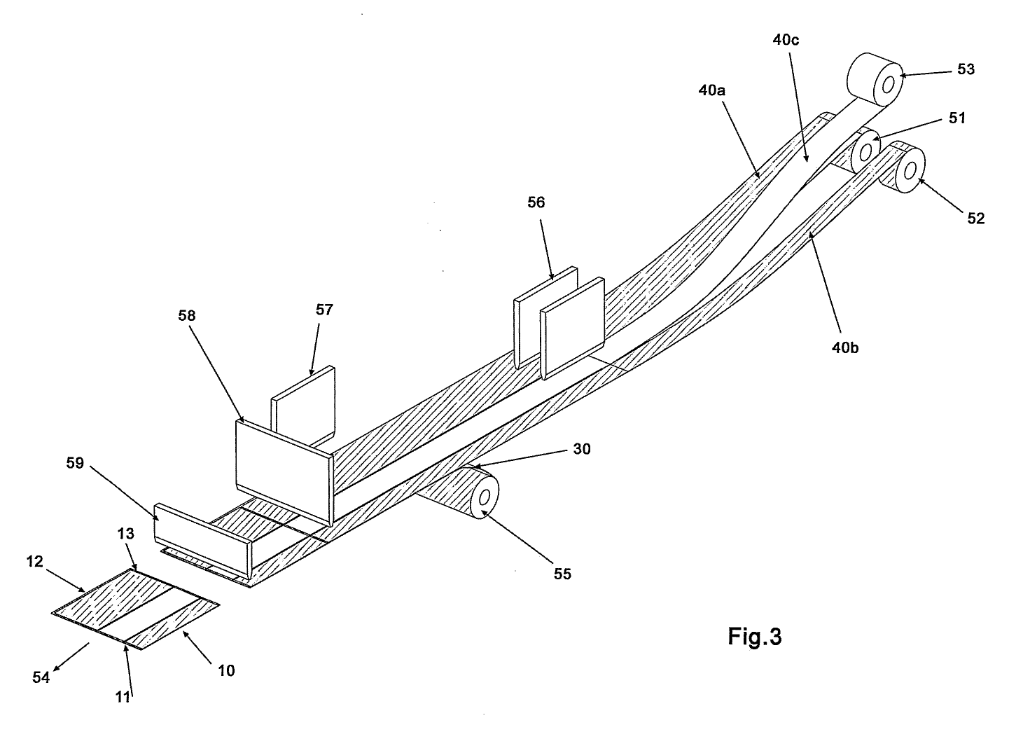

FIG. 2 is an exploded view illustrating the back flexible sheet 30 and the three strips 40a, 40b, 40c of the front flexible sheet 40. FIG. 3 schematically illustrates a continuous production line for bonding the foregoing strips and sheets together to produce the package 10 in a stepwise mechanical manner.

Thus, as shown in FIG. 3, the front strips 40a, 40b of the front flexible sheet 40, are concurrently fed from rolls 51, 52 and 53, respectively, with, and on opposite sides of, the multi-layer transparent polymer strips 40c of the front flexible sheet 40 from supply rolls 40a, 40b and 40c respectively, along a longitudinal path indicated by arrow 54. The multi-layer aluminum-foil laminate sheet defining the back flexible sheet 30 is supplied from another roll 55 to underlie the three strips of the front flexible sheet 40. A pair of heat-sealing bars 56 are located upstream of supply roll 55 on opposite sides of the central multi-layer transparent-polymer strips 40c to bond the strips 40a, 40b to the opposite edges of the central strip 40c. The three-part front flexible sheet 40 is thus produced before it reaches supply roll 55 for the back flexible sheet 30.

At a point downstream of supply roll 55 supplying the back flexible sheet 30, another heat sealing bar 57 is provided to bond the front flexible sheet 40 to the back flexible sheet 30 along a longitudinal edge. Slightly further downstream of supply roll 55, another heat-sealing bar 58 extends transversely of the two sheets and is intermittently activated to bond them together along longitudinally-spaced transverse bond lines. Slightly further downstream, a cutter blade 59 periodically cuts the bonded sheets along transverse cut lines, to produce the individual packages 10 having the three bonded edges 11, 12 and 13 with the fourth edge open to permit introduction of the products being packaged.

FIG. 4 illustrates an example of a multilayer laminate that contains an aluminum-foil layer construction which may be used for the back flexible sheet 30, as well as for the two strips 40a, 40b of the front flexible sheet 40. As shown in FIG. 4, such a multi-layer laminate containing aluminum-foil includes an aluminum layer 31 laminated by an adhesive layer 32 to a polymer substrate 33, with a vacuum-coated barrier layer 34 inbetween. Aluminum-foil 31 further carries, on its opposite surface, a sealing layer 35 bonded thereto by another adhesive layer 36. Barrier layer 34 on one side of the aluminum-foil 30 is effective to enhance the moisture-barrier or gases of the aluminum foil, and thereby to reduce dramatically the penetration of moisture therethrough.

As one example, aluminum layer 31 may be aluminum-foil of less than 20 microns, preferably 6 microns, in thickness; the substrate 33 may be a polyester such as PET (polyethylene teraphtalate) or polypropylene; the vacuum-deposit barrier layer 34 may be a vacuum-coated metal or oxide, such as alumina silicon dioxide, aluminum oxide, indium/tin oxide, etc.; sealing layer 35 may be polyethylene or polypropylene; and the two adhesive layers 32, 36 may be a polyurethane solvent based adhesive.

As indicated earlier, the same multi-layer aluminum-foil construction may also be used for the two strips 40a, 40b of the front flexible sheet 40.

FIG. 5 illustrates an example of a multi-layer transparent-polymer construction which may be used for the optically-transparent strip 40c of the front flexible sheet 40. The optically-transparent section 40c of the front flexible sheet 40 is a multi-layer lamination including a first transparent polymer substrate having a first vacuum-coated moisture-barrier layer, bonded to a second transparent polymer substrate having a second vacuum-coated moisture-barrier layer. In addition, a transparent sealing layer is applied on the opposite sides of the multi-layer lamination.

Thus, as shown in FIG. 5, the multi-layer transparent polymer lamination includes, in this order: a transparent sealing layer 41, an adhesive layer 42, a transparent polymer substrate 43, a vacuum-coated transparent barrier layer 44, another adhesive layer 45, another transparent polymer substrate 46, another vacuum-coated barrier layer 47, a further adhesive layer 48, and a transparent sealing layer 49.

The two transparent sealing layers 41, 49 may be polyethylene or polypropylene; the two transparent polymer substrates 43, 46 may be a polyester resin, such as PET; the two transparent barrier layers 44, 47 may be a vacuum-coated metal or oxide, such silicon dioxide, aluminum oxide, indium/tin oxide, etc.; and the adhesive layers 42, 45 and 48, may be a polyurethane adhesive.

FIG. 6 illustrates another construction of a flexible package in accordance with the present invention. The package illustrated in FIG. 6, therein generally designated 220, is also constructed for receiving products, such as indicated at 210, having a high sensitivity to moisture. Package 220 illustrated in FIG. 6 thus also includes a back flexible sheet 230 bonded to a front flexible sheet 240, but in this case both flexible sheets are of the multi-layer laminate that contains an aluminum-foil layer construction, corresponding to the construction of the back flexible sheet 30 in FIG. 1, as illustrated in FIG. 4. However, the transparent sections of the front flexible sheet 240 are provided by forming, in the front flexible sheet, a plurality of openings defining windows 241, 242, of sufficient number, and appropriately located, to permit viewing the humidity indicator, the desiccant, the bar-code label, and/or the RFID unit, as desired to be included in the package for the respective product. Here, the two flexible sheets 230, 240 in the package of FIG. 6 would be of the same multi-layer laminate that contains aluminum-foil layer construction as the back flexible sheet 30 in the package 10 of FIGS. 1-5; and each of the window openings 241, 242 would be covered by a transparent polymer sheet of similar construction as the transparent strip 40c in the package illustrated in FIGS. 1-5.

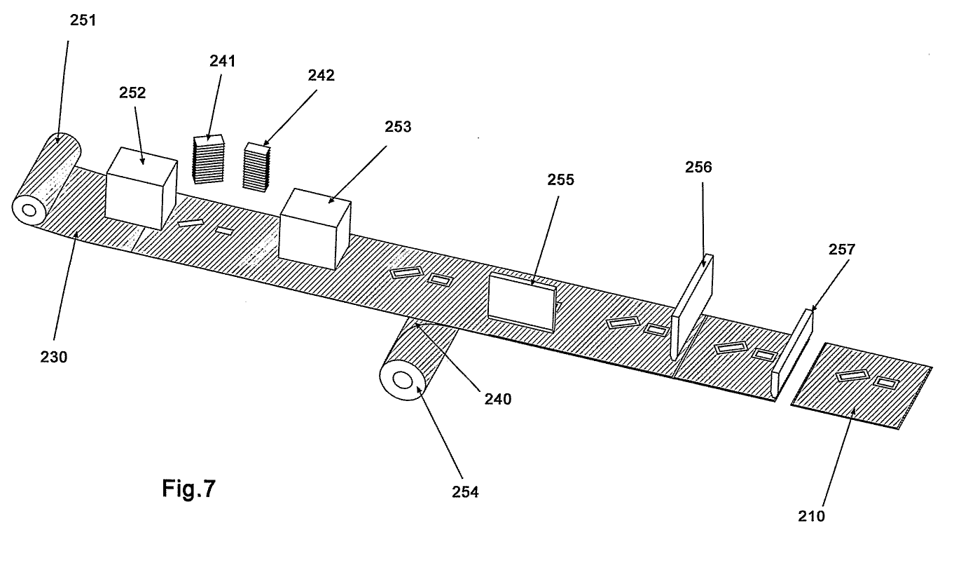

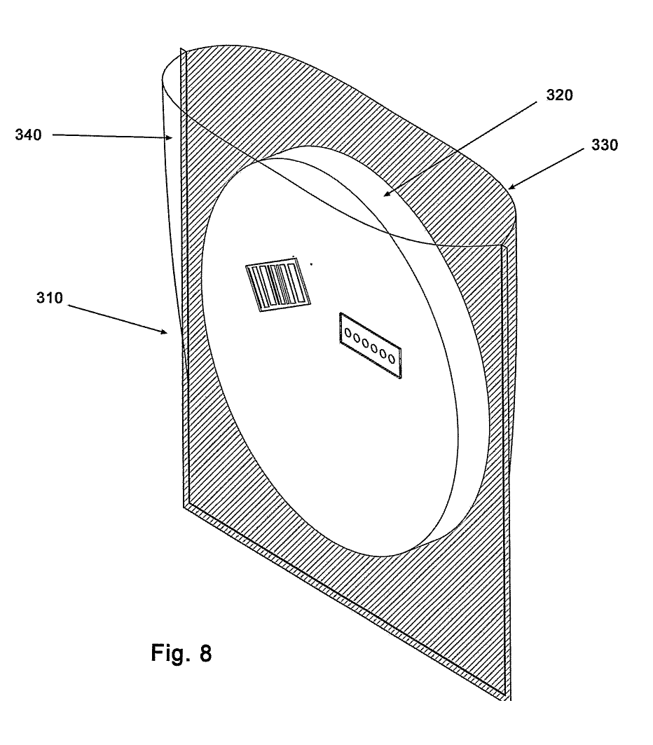

FIG. 7 schematically illustrates apparatus for producing the packages 220 illustrated in FIG. 6 on a continuous basis. Thus, as seen in FIG. 7, the front flexible sheet 230 is supplied from a supply roll 251. It is fed past a punching station 252 which punches-out the windows 241, 242; and then passes through a patching station 253 where patches of optically-transparent moisture-resistance sheets are applied to cover and seal the windows 241, 242. The front flexible sheet 230 is then passed to a station containing a supply roll 254 which feeds the back flexible sheet 240, then through a bonding station containing a heat-sealing bar 255 for continuously bonding the two sheets along one longitudinal edge; then through another bonding station containing another heat-sealing bar 256 which intermittently bonds the two sheets along longitudinally-spaced transverse bond lines to define a plurality of individual compartments each having an open end; and finally through a cutting station in which a cutter 257 cuts the sheets along longitudinally-spaced transverse lines, to produce the individual packages 210 each having a compartment and an open end for inserting a product into the respective compartment.

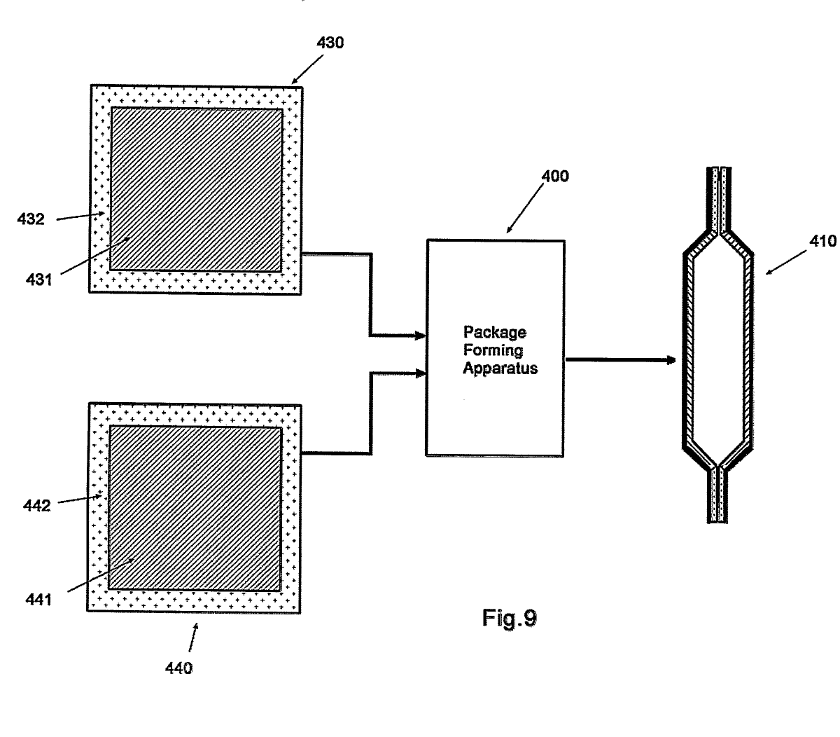

FIG. 8 illustrates a further flexible package, therein generally designated 310, constructed in accordance with the present invention for packaging products 320 sensitive to moisture. In the package construction of FIG. 8, the back flexible sheet 330 is of the aluminum-foil laminate construction described above with the respect to the back flexible sheet 30 in FIGS. 1 and 4. However, the front flexible sheet 340 is completely of an optically-transparent moisture-resistant sheet. It is of the same multi-layer transparent-polymer sheet material as strip 40c in package 10 illustrated in FIG. 1, and more particularly described with respect to FIG. 5. Thus, the front flexible sheet 340 in package 310, although completely transparent for its entire surface, would also provide a high degree of moisture resistance as described above with respect to FIGS. 1 and 5.

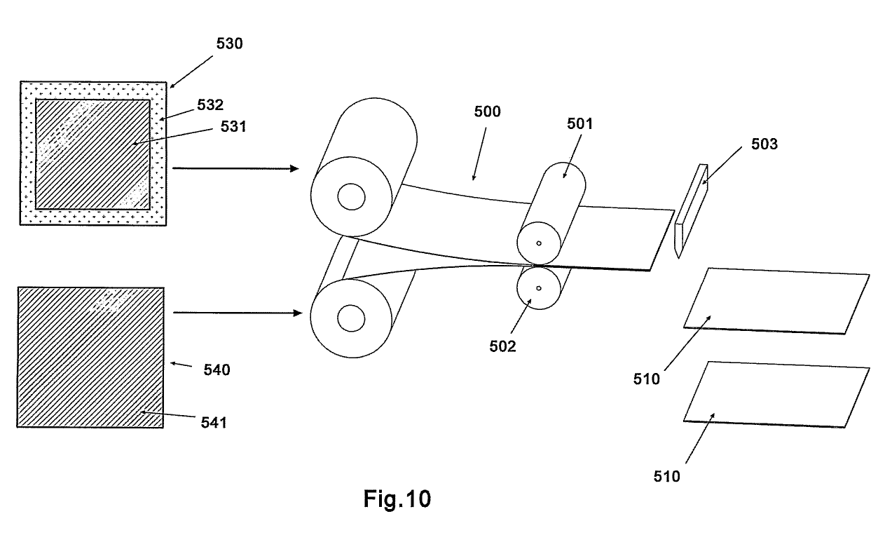

It is also highly desirable to provide packages with anti-static properties, in order to prevent the build-up of static charges, and/or to provide electromagnetic shielding. FIGS. 9 and 10 illustrate two methods of producing packages in accordance with the present invention and having such anti-static properties.

Anti-static and/or electromagnetic shielding properties may be provided in such a package by coating the inner surfaces of the two flexible sheets with an anti-static coating, such as a polyaniline, indium tin oxide nano-particles, Baytron® and alike. However, such anti-static coatings do not bond well to each other, and therefore the use of such coatings can present problems in bonding the two flexible sheets along their peripheral edges in order to produce the compartments for receiving the products to be packaged.

FIG. 9 schematically illustrates one construction of a package and a method for making such packages which overcomes this problem.

As illustrated in FIG. 9, a package (or pouch) forming apparatus, generally designated 400, continuously produces flexible packages 410 from two flexible, moisture-barrier sheets 430, 440. The two sheets 430, 440 may be of any of the multi-layer constructions described above with respect to sheets 30, 40 of FIG. 1, and as more particularly described in FIGS. 4 and 5, respectively, except that each of the sheets would be provided, on its inner face (i.e. the face confronting the other sheet) with an anti-static coatings 431, 441, respectively, for example of a polyaniline. As shown in FIG. 9, the anti-static coating 431, 441, cover only the central area of the respective sheet; that is, they do not cover the outer margins, shown at 432, 442, which are to be bonded together to define the compartment for receiving the product to be packaged.

One way of producing the construction illustrated in FIG. 9 is to print the anti-static coating on each of the two continuous sheets used for making the packages (e.g., as illustrated in FIG. 7) to cover only the central areas 431, 441, of each sheet, and not to cover the margins 432, 442, to be bonded in order to produce the packages. Thus, by printing the anti-static coatings and/or electromagnetic shielding only in the central areas 431, 441, of each sheet, this exposes the underlying sealing layer of each sheet (e.g. sealing layer 35 in the multi-layer laminate that contains aluminum foil layer sheet 30 and sealing layer 49 in the multi-layer transparent polymer sheet 40) in the outer margins 432, 442 for producing the bond lines in the respective packages.

Another way of producing the configuration illustrated in FIG. 9 is to continuously coat the anti-static coating on the respective face of the continuous sheet, or to use a polymer with inherent anti-static properties in the inner side of a multilayer laminate that makes the pouch, and to print an adhesive border in the margins 432, 442, for bonding the two sheets together. The adhesive printed in the margins 432, 442, could be any conventional adhesive, such as those used in the FIGS. 4 and 5 multi-layer constructions, and the apparatus could be that of FIG. 7 utilizing an intermittently-activated heat-sealing bar 256 for bonding the two sheets along transverse lines to produce the compartments of the respective packages.

FIG. 10 illustrates another method and apparatus for producing flexible packages in accordance with the present invention having anti-static properties. The method illustrated in FIG. 10 includes a conventional laminating apparatus, generally designated 500, including heating rolls 501, 502, and a transversely-extending cutter bar 503, for producing the packages 510 from two continuous, flexible sheets 530, 540. The two flexible sheets 530, 540 could also be of the same multi-layer constructions described above particularly with respect to FIGS. 4 and 5.

In this case, however, the anti-static and/or electromagnetic shielding coating would be continuously applied to the inner faces of both sheets, or a polymer having anti-static and/or electromagnetic shielding properties would be used for the inner face; and a heat-activatable adhesive would be applied to the outer margins of one sheet (or both sheets) serving as the bond lines for producing the compartments in the respective packages 510. Thus, as shown in FIG. 10, both sheets 530, 540, are continuously coated with the anti-static coating 531, 541, respectively, and a frame of heat-activatable adhesive is printed on one of the sheets, as shown at 532 in FIG. 10. Accordingly, when the two sheets 530, 540, are fed between the heating rollers 501, 502 of the apparatus 500, the heating rollers will activate the adhesive in the outer margins 532 to bond the two sheets together along those margins.

An example of the heat-activated adhesive used in the method illustrated in FIG. 10 is Adcoat 295G supplied by Rohm and Haas (US); and an example of the normal adhesive used in the other described embodiments is Adcoat 509R, also supplied by Rohm and Haas (US). An example of the roller heating apparatus illustrated in FIG. 10 is GMP of South Korea; whereas an example of the package-making (or pouch-making) apparatus illustrated in the other drawings is that supplied by Totani of Japan or Waterline of Switzerland.

Examples of vacuum coated transparent polymers are Techbarier® of Mitsubishi plastics of Japan.

Examples of antistatic and/or electromagnetic shielding is polyaniline of Panipol, Finland, Baytron® of H.C Starck of Germany and Indium tin oxide nano-particles of Degussa, Germany.

While the invention has been described with respect to several preferred embodiments, it will be appreciated that these are set forth merely for purposes of example, and that many other variations, modifications and applications of the invention may be made.

What is claimed is:

1. A flexible package for a product sensitive to moisture, comprising:
a front flexible sheet having moisture-barrier properties;
and a back flexible sheet having moisture-barrier properties joined along its peripheral edges to the peripheral edges of said front flexible sheet except for one edge thereof to define a compartment allowing the introduction of the product and then the sealing of the package by bonding the unjoined edges;
wherein at least a section of said front flexible sheet having moisture-barrier properties is optically transparent, such as to permit a moisture-indicator, a bar code label, and/or an RFID (radio frequency identification device) to be introduced with the product into the interior of the package before bonding said one edge of the two sheets, and to be optically observed through said transparent section after the package has been sealed by bonding said one edge.

2. The package according to claim 1, wherein said front flexible sheet and said back flexible sheet are of an opaque material having moisture-barrier properties, except for said transparent section of the front flexible sheet which is of an optically transparent material having moisture-barrier properties.

3. The package according to claim 2, wherein said transparent section of the front flexible sheet extends across the complete width of the front flexible sheet.

4. The package according to claim 2, wherein said transparent section of the front flexible sheet includes at least one transparent window formed in the front flexible sheet.

5. The package according to claim 4, wherein said transparent section of the front flexible sheet includes a plurality of said transparent windows such as to permit a moisture-indicator as well as a bar code label, and/or a radio-frequency identification device (RFID), to be introduced with the product into the interior of the package before bonding said one edge of the two sheets.

6. The package according to claim 2, wherein said front flexible sheet is optically transparent for its complete surface area.

7. The package according to claim 2, wherein said back flexible sheet includes a polymer substrate, a vacuum-coated moisture barrier layer thereover, and a metal foil of less than 20 microns over said moisture-barrier layer.

8. The package according to claim 7, wherein said metal foil is of aluminum,

9. The package according to claim 7, wherein said moisture-barrier layer is a vacuum-coated metal or oxide.

10. The package according to claim 2, wherein said transparent section of the front flexible sheet comprises a multi-layer lamination including a first transparent polymer substrate having a first vacuum-coated moisture-barrier layer, bonded to a second transparent polymer substrate having a second vacuum-coated moisture-barrier layer.

11. The package according to claim 10, wherein said first and second transparent polymer substrates are adhesively joined to each other.

12. The package according to claim 10, wherein said transparent section of the front flexible sheet further includes a transparent sealing layer on the opposite faces of said multi-layer lamination.

13. The package according to claim 12, wherein said transparent sealing layers are adhesively joined to the opposite faces of said multi-layer lamination.

14. The package according to claim 1, wherein the inner faces of said front flexible sheet and said back flexible sheet are coated with an anti-static and/or electromagnetic shielding coating to dissipate electrical charges.

15. The package according to claim 14, wherein the inner faces of said front flexible sheet and said back flexible sheet are coated with a sealing layer, and said anti-static coating covers the complete surface of said sheets except for outer margins along the edges to be bonded at said sealing layer.

16. The package according to claim 14, wherein said anti-static and/or electromagnetic shielding coating covers the complete surface of said sheets, and an adhesive material is applied over said anti-static coating only at the outer margins along the edges to permit bonding said edges.

17. A flexible package for a product sensitive to moisture, comprising:
a front flexible sheet having moisture-barrier properties;
and a back flexible sheet having moisture-barrier properties joined along its peripheral edges to the peripheral edges of said front flexible sheet except for one edge thereof to define a compartment allowing the introduction of the product and then the sealing of the package by bonding said one edge;
Wherein at least one of said flexible sheets includes a polymer substrate, a vacuum-coated moisture-barrier layer thereover, and a metal foil of less than 20 microns in thickness over said moisture-barrier layer.

18. The package according to claim 17, wherein said metal foil is of aluminum,

19. The package according to claim 17, wherein said moisture-barrier layer is a vacuum-coated metal or oxide.

20. The package according to claim 17, wherein the other of said flexible sheets is a multi-layer lamination including a first polymer substrate having a first vacuum-coated moisture-barrier layer, bonded to a second polymer substrate having a second moisture-barrier layer.

21. The package according to claim 20, wherein said first and second polymer substrates are adhesively joined to each other.

22. The package according to claim 20, wherein said multi-layer lamination includes a sealing layer on the opposite faces thereof.

23. The package according to claim 22, wherein said sealing layers are adhesively joined to the opposite faces of said multi-layer lamination.

24. The package according to claim 17, wherein the inner faces of said front flexible sheet and said back flexible sheet are coated with anti-static coating to dissipate electrical charges, and/or to provide electromagnetic shielding.

25. The package according to claim 24, wherein the inner faces of said front flexible sheet and said back flexible sheet are coated with a sealing layer, and said anti-static and/or electromagnetic shielding coating covers the complete surface of said sheets except for outer margins along the edges to be bonded at said sealing layer.

26. The package according to claim 24, wherein said anti-static and/or electromagnetic shielding coating covers the complete surface of said sheets, and an adhesive material is present over said anti-static coating only at the outer margins along the edges to permit bonding said edges.

27. A flexible package for a product sensitive to moisture, comprising:
a front flexible sheet having moisture-barrier properties;
and a back flexible sheet having moisture-barrier properties joined along its peripheral edges to the peripheral edges of said front flexible sheet except for one edge thereof to define a compartment allowing the introduction of the product and then the sealing of the package by bonding said one edge;
Wherein at least one of said flexible sheets is a multi-layer lamination including a first polymer substrate having a first vacuum-coated moisture-barrier layer, bonded to a second polymer substrate having a second vacuum-coated moisture-barrier layer.

28. The package according to claim 27, wherein said first and second polymer substrates are adhesively joined to each other.

29. The package according to claim 27, wherein said multi-layer lamination includes a sealing layer on the opposite faces thereof.

30. The package according to claim 27, wherein said sealing layers are adhesively joined to the opposite faces of said multi-layer lamination.

31. The package according to claim 27, wherein the inner faces of said front flexible sheet and said back flexible sheet are coated with an anti-static and/or electromagnetic shielding coating to dissipate electrical charges.

32. The package according to claim 31, wherein the inner faces of said front flexible sheet and said back flexible sheet are coated with a sealing layer, and said anti-static and/or electromagnetic shielding coating covers the complete surface of said sheets except for outer margins along the edges to be bonded at said sealing layer.

33. The package according to claim 31, wherein said anti-static and/or electromagnetic shielding coating covers the complete surface of said sheets and an adhesive material is present over said anti-static coating only at the outer margins along the edges to permit bonding said edges.

34. A flexible package for a product sensitive to moisture, comprising:
A front flexible sheet;
and a back flexible sheet joined along its peripheral edges to the peripheral edges of said front flexible sheet except for one edge thereof to define a compartment allowing the introduction of the product and then the sealing of the package by bonding said one edge;
Wherein the inner face of said front flexible sheet and back flexible sheet are coated with an anti-static and/or electromagnetic shielding coating to dissipate electrical charges and/or to provide electromagnetic shielding.

35. The package according to claim 34, wherein the inner faces of said front flexible sheet and said back flexible sheet are coated with a sealing layer, and said anti-static and/or electromagnetic shielding coating covers the complete surface of said sheets except for outer margins along the edges to be bonded at said sealing layer.

36. The package according to claim 34, wherein said anti-static and/or electromagnetic shielding coating covers the complete surface of said sheets and an adhesive material is present over said anti-static coating only at the outer margins along the edges to permit bonding said edges.

37. A flexible sheet in the form of a multi-layer lamination including a first polymer substrate having a first vacuum-coated moisture-barrier layer, bonded to a second polymer substrate having a second vacuum-coated moisture-barrier layer.

38. The flexible sheet according to claim 37, wherein said first and second flexible sheet substrates are adhesively joined to each other.

39. The flexible sheet according to claim 37, wherein said multi-layer lamination includes a sealing layer on the opposite faces thereof.

40. The flexible sheet according to claim 37, wherein said sealing layers are adhesively joined to the opposite faces of said multi-layer lamination.

41. The flexible sheet according to claim 37, wherein the inner faces of said front flexible sheet and said back flexible sheet are coated with an anti-static coating to dissipate electrical charges, and/or to provide electromagnetic shielding.

42. The flexible sheet according to claim 41, wherein the inner faces of said front flexible sheet and said back flexible sheet are coated with a sealing layer, and said anti-static coating covers the complete surface of said sheets except for outer margins along the edges to be bonded at said sealing layer.

43. The flexible sheet according to claim 41, wherein said anti-static and/or electromagnetic shielding coating covers the complete surface of said sheets and an adhesive material is present over said anti-static coating only at the outer margins along the edges to permit bonding said edges.

44. The flexible sheet according to claim 37, wherein said substrate and said vacuum-coated moisture-barrier layers are transparent.

45. A method of making flexible packages, comprising:
feeding two flexible polymer sheets, each having a moisture-barrier layer, through a longitudinally-extending path, with a surface of each sheet facing a surface of the other sheet;
bonding the two sheets together along longitudinally-spaced transverse lines to define a plurality of individual compartments each having an open end;
and cutting said bonded sheets along longitudinally-spaced transverse cut lines to define a plurality of individual packages each having a said compartment and a said open end for inserting a product into the respective compartment;
wherein said surfaces of the two sheets facing each other are coated with an anti-static coating before the two sheets are bonded together along said transverse bond lines, to thereby impart anti-static properties to each of said packages, and/or to provide electromagnetic shielding.

46. The method according to claim 45, wherein one of said flexible sheets is opaque, and the other of said flexible sheets includes an optically-transparent section to enable viewing the interior of the respective compartment.

47. The method according to claim 46, wherein said optically-transparent section of said other flexible sheet extends for the complete width thereof.

48. The method according to claim 46, wherein said optically-transparent section of said other flexible sheet is in the form of a plurality of windows integrally formed therein.

49. The method according to claim 46, wherein said other flexible sheet is completely transparent.

50. The method according to claim 45, wherein said anti-static coating is applied to each of said facing surfaces except outer margins to be bonded together, and wherein said bonding is effected by intermittently activating a heating element extending transversely across the two flexible sheets in said longitudinally-extending path.

51. The method according to claim 45, wherein:
said antic-static coating is applied over the complete surfaces of each of said facing surfaces of the two sheets;
an adhesive is applied over said anti-static and/or electromagnetic shielding coatings only along the outer margins to be bonded together;
and said bonding is effected by intermittently activating a heating element extending transversely across the two flexible sheets in said longitudinally-extending path.

52. The method according to claim 45, wherein:
said anti-static and/or electromagnetic coating is applied over the complete surface of each of said facing surfaces of the two sheets;
a heat-activatable adhesive is applied over said anti-static coating of at least one sheet only along the outer margin to be bonded to the other sheet;
and said bonding is effected by feeding the two sheets between heater rollers for activating said heat-activatable adhesive.
